(19) United States
(12) Patent Application Publication
(10) Pub. No.: US 2021/0107069 A1
(43) Pub. Date: Apr. 15, 2021

(54) Adaptive Work-Stop

(71) Applicant: Daniel R. Kenner, Littleton, CO (US)

(72) Inventor: Daniel R. Kenner, Littleton, CO (US)

(21) Appl. No.: 17/067,713

(22) Filed: Oct. 11, 2020

Related U.S. Application Data
(60) Provisional application No. 62/914,482, filed on Oct. 13, 2019.

(51) Int. Cl. B23B 31/20

(52) U.S. Cl. CPC B23B 31/208

(57) ABSTRACT

A work-stop assembly in a work-holding-collet is formed of a main work-stop body selectively mounted on the rear of the work-holding-collet and defining a longitudinal through passageway aligned with the collet mouth. First and second work-stop position adjusters allow coarse adjustment of the position of a work-stop element by one of the adjusters while the work-stop assembly is removed from the work-holding collet and allow more precise adjustment by the other adjuster after the work-stop assembly is mounted to the work-holding collet. One of the adjustments employs a slidable relationship between the adjuster and the passageway, and one of the adjusters carries the work-stop element for axial movement in the work-holding-collet to set an adjustable depth limit for a workpiece inserted from a workpiece-receiving mouth at the front of the work-holding-collet.

### BACKGROUND OF THE INVENTION

### Field of the Invention

The invention relates to chucks or turning and particularly to chucks with simultaneously acting jaws and longitudinally split sleeves, e.g. collet chucks, with a tool or workpiece positioning stop. The invention also relates to chucks, an accessory or component thereof, and a tool or work stop or locator.

### Description of Related Art

including information disclosed under 37 CFR 1.97 and 1.98—Collet chucks provide a mechanical connection on machine tools to carry a tool or a workpiece in proper position for cutting or forming. A basic collet is an axially extending tube with a flared front end where the tube wall is split into several axial fingers or jaws. The interior of the tube extending rearward from the flared front can be referred to as a capacity bore, since within the capacity of the collet this area receives a portion of a workpiece. The workpiece can be placed in the capacity bore of the tube on the central axis of the tube. At the rear of the capacity bore, the tube is precision threaded to receive a stop body with matching precision threads. The stop body is threaded into the rear of the capacity bore and grounded against the rear face of the collet, creating a fixed spatial relationship between the collet and the stop body. The stop body itself has a threaded axial bore that fits a threaded collet stop, which is advanced from the rear of the stop body, through the stop body, and into the capacity bore of the collet to a desired spacing behind the front of the collet. Once the collet stop is properly placed at the desired distance, a lock nut is threaded over the collet stop from the rear end and secured against the rear end of the stop body, thus locking the position of the collet stop with its front end in the desired placement behind the front of the collet.

In the operation of the machine tool, a compressing collar can then be drawn over the flare of the collet to compress the jaws against the workpiece, thus locking the workpiece concentrically in the collet. The collet is an interface between the workpiece and the machine tool. It not only holds the workpiece in a concentric position, but it holds the workpiece in a fixed axial extension from the front of the collet. In a typical example, the collet also engages the machine tool, such as on a rotary spindle, so that the machine tool can spin the workpiece with great precision about the central axis. A cutting or shaping element of the machine tool can then be applied to the portion of the workpiece extending axially forward from the collet. When the work is complete, the jaws are opened by withdrawing the compressing collar, and the workpiece is removed from the front end of the collet. Such collets are commonly used on lathes, milling machines, and the like.

Collets are available in a limited selection of different capacities and can be exchanged on a machine tool to fit the task at hand. Establishing a proper position between the collet and the carried tool or workpiece desirably is done with speed and accuracy. Particularly, when a single collet is in sequential use to make a series of identical workpieces, each workpiece must be positioned identically in the capacity bore of the collet to ensure that the completed workpieces are identical in length. To achieve this result, a collet is provided with a collet stop at a selected depth in the capacity bore so that each workpiece can be inserted identically, until it strikes the collet stop. Commensurately, whether a series of workpieces or a single workpiece require a particular depth to the collet stop, the process of accurately setting the stop must be accomplished with reasonable efficiency and precision. Thus, the most desirable characteristics of a collet stop are speed of precise initial setting and durability of a setting to remain accurate through repetitive uses.

Adjusting or transferring a collet stop even in the previously described basic collet is time consuming, which is a form of inefficiency and economic loss. An array of tools is needed to remove and reinsert a collet stop. Because the typical collet stop is threaded into place and locked by a lock nut, both the lock nut and the collet stop, itself, must be both loosened and withdrawn from the stop body to change size or axial position of the stop. These steps not only consume time but also wear on the threaded components. For example, grounding and ungrounding the stop body against the rear of the collet might wear both the threads and the grounded surfaces. Locking a locknut and then backing it off also has the capacity to wear on threads and wear on abutting surfaces.

A recent variation of the basic collet stop is shown in U.S. Pat. No. 5,772,219 to Vossen, which shows an outer clamping collet that contains an interior stop-adjusting mechanism. This mechanism employs a small, single ended, coaxial collet that fits in the capacity bore of the clamping collet. The small collet closely fits over a wide diameter center length of a complex stop-rod. A wide center length of the stop-rod is a mounting portion that can be moved axially in the small collet and gripped where necessary by the jaws of the small collet. The complex stop-rod also has a forward extension that is narrower in diameter than the wide center length. The narrow portion serves as the collet stop portion and is held at a selected axial position in the capacity bore. The available positions of the narrow extension are limited by the requirement that the wide center length is the only part of the stop-rod that the small collet can grip, which prohibits the stop-rod from forward placement beyond where the wide portion can be clamped in the jaws of the small collet. Accordingly, the narrow stop-rod must be placed primarily toward the front of the capacity bore. The small collet is fastened in the clamping collet near the rear of the capacity bore. It is held by a stop body that is threaded into the rear of the clamping collet and grounded against the rear of the clamping collet. A lock nut screws onto the rear of the small collet and pulls back the small collet within the stop body, causing the stop body to compress the jaws of the small collet to grip the wide center section of the stop-rod. Notably, the stop body can neither remain in one place nor move forward to compress the jaws of the small collet. Instead, the small collet must move backwards for the jaws to clamp on the stop-rod. This backwards movement of the small collect will introduce error into the resulting position of the stop-rod as it is clamped. The complex stop-rod also is a disadvantage because replacement rods must be custom fabricated, which adds undesirable expense and loss of time to jobs.

It would be desirable to have a collet stop assembly that can accommodate an extended range of stop elements.

It would be desirable to have a collet stop assembly that can be adjusted to different stop positions and sizes by substitution with standard size, widely available components.

It would be desirable to have a collet stop that can be changed quickly, such as, for example, a matter of seconds rather than a period of minutes that might be a substantial portion of an hour.

It would be desirable to have a collet chuck that enables changeover of a collet stop with ability to quickly and precisely establish a desired stop depth.

It would be desirable to employ a fastening system for a collet stop or stop-rod that retains the accuracy of a selected position while securing the collet stop in fixed position.

To achieve the foregoing and other objects and in accordance with the purpose of the present invention, as embodied and broadly described herein, the method and apparatus of this invention may comprise the following.

### BRIEF SUMMARY OF THE INVENTION

Against the described background, it is therefore a general object of the invention to provide a rapidly exchanged and accurate work stop member for a work-holding-collet.

According to the invention, a work-holding-collet is formed of: a body with flared front end defining a ring of compressible jaws around a central work-receiving collect mouth. A capacity bore is within the collet body, rearward of the flared front end. A work-stop body is releasably attached to the rear of the body of the work-holding-collet and defines a through passageway longitudinally aligned with the mouth of the work-holding-collet.

In a first embodiment, an internal stop-collet is carried for longitudinal movement with respect to the work-stop body, and the stop-collet also is carried in longitudinal alignment with the mouth. In use, the stop-collet can carry a work stop at a variably selected distance behind the mouth. The purpose of a work stop is to lie in the rear path of a workpiece being inserted into a work-holding-collet and to block such insertion at a predetermined depth of insertion. Thus, a work stop also accurately can be called as a depth stop. This component most commonly is embodied as a rod or pin. A work stop-rod or depth stop-rod has a front end that is contacted by the rear of a workpiece as it is inserted through the mouth and blocks further insertion of a workpiece. The stop-collet is mounted to an intermediate shank that is slidable in the axial passageway of the work-stop body, allowing the shank and stop-collet to move axially, placing the front end of the work stop-rod within the capacity bore at a selected spacing behind the collet mouth for, in use, blocking rearward extension of a workpiece inserted in the collet mouth. The work-stop body has an associated lock operable between the intermediate shank and the through passageway to secure the intermediate shank in a fixed position with respect to the passageway;

In a second embodiment, a work-holding-collet is adapted to handle the special problems of using a tee-square stop. This type of stop is characterized by a broad head on a considerably narrower shaft, thus resembling the letter “T” in side view. The narrower shaft can be accommodated in the internal stop-holding collet, while the broad head is of too large a diameter to fit the internal stop-holding collet. The problem that arises is that a small offset from perfect centering of the shank in the passageway of the work-stop body is translated into a wobble of the broad head of the tee-square stop. The solution is to proportion the passageway to have one or more centrally located setscrews centrally located from end to end. Preferably there are two spaced-apart setscrew locations in a central segment of the passageway with equal end segments of the passageway extending forward and rearward from the central segment. Thus, the equal forward and rearward segments of the passageway stabilize the shaft to turn on the centerline of the work-holding-collet and in good alignment with the spindle of the machine tool that eventually carries the work-holding-collet.

In a third embodiment, instead of carrying the shank, the passageway slidably carries a tube stop, which is a hollow tube structure with an open front end and a workpiece-blocking rear closure. The tube stop slides axially in the passageway for longitudinal displacement with respect to the mouth of the work-holding-collet, placing the rear end of the tube stop rearward of the work-stop body at a variably selected spacing behind the mouth of the work-holding-collet for, in use, blocking further rearward extension of a workpiece that has been inserted in the mouth of the work-holding-collet. The tube stop has an associated lock operable between the tube stop and the through passageway, securing the tube stop in a fixed longitudinal position with respect to the passageway.

According to a further aspect of the invention, where the stop-collet is present, the associated lock on the work-stop body is a setscrew applied through the work-stop body, into the passageway, and into contact with the intermediate shank. The intermediate shank defines a flat longitudinal edge that is positionable in the passageway to be the contact surface for the set screw.

Still further, the intermediate shank is adapted to cooperate with work stop-rods of different diameters. The shank contains a cavity that is suitable to receive stop-collets of a range of capacities, thereby adapting the work-holding-collet to operate with work stop-rods sized over a range of sizes.

According to another aspect of the invention, where a tube stop is used with the passageway, the associated lock applied to the tube stop is a setscrew applied through the work-stop body, into the passageway, and into contact with the tube stop. Because the wall of the tube stop may be less strong than the wall of a shank, the setscrews may engage the tube stop in a novel way. The wall of the tube stop is configured with multiple rows of reception holes in the tube wall, with reception holes of some rows being axially offset from others. The tube stop can be positioned for different reception holes to align with and receive the set screws.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is an exploded view taken from a front and side position of a first embodiment of the invention, showing a work-holding-collet with a broken away lower right corner showing internal threading.

FIG. 2 is a vertical cross-section of a work-stop assembly taken at the plane 2-2 of FIG. 1, showing an assembled view of an intermediate shank, internal stop-holding collet, stop nut, together with an installed gage pin, and showing in non-sectional view a work-stop body.

FIG. 3 is a view similar to FIG. 1, showing a second embodiment of the invention.

FIG. 4 is a vertical cross-section of a work-stop assembly, in part taken at the plane 4-4 of FIG. 3, showing an assembled view of an intermediate shank, internal stop holding collet, stop nut, and an additional T-square stop, and showing a work-stop body in a non-sectional view.

FIG. 5 is vertical cross-section of a work-holding-collet, taken through a front-to-rear centerline.

FIG. 6 is a view similar to FIG. 1, showing a third embodiment of the invention employing a tube stop.

FIG. 7 is the work-stop assembly of FIG. 6 with a tube stop portion in vertical cross section taken at the plane 7-7 of FIG. 6, additionally showing in phantom a workpiece, and showing an assembled, non-sectional view of a work stop-rod and lock nut.

### DETAILED DESCRIPTION OF THE INVENTION

The invention is an adaptive work-stop assembly that typically will be mounted at the rear of and partially inside a work-holding-collet during use. Another, smaller, internal collet will be referred to as the stop-collet. The latter is part of an embodiment of the work-stop assembly and fits within the work-holding-collet to hold a work stop-rod. Typically the work-holding-collet will be mountable on a rotary spindle of a machine tool. In the setup of a rotary machine tool, collets often are used to hold a tool that will he applied to a workpiece. In addition, collets often are used to hold a workpiece that a tool will be applied to in order to position the tool to shape the workpiece.

For convenience of description, the invention will be referred to as operating with a carried workpiece, with the defined meaning that a workpiece refers not only in one sense to an object being modified but also in a second sense to an object performing the modification commonly referred to as a tool. Precision placement of both is needed to setup a machine for automated operation. Opposed work-holding-collets can be selectively used to position both the conventional workpiece and the tool. In either or both usages, the work-holding-collet allows positional adjustment between a tool and the conventional workpiece so dial the tool and the conventional workpiece come together at a desired working relationship. Particularly, the work-holding-collet holding the workpiece or tool serves the additional function of being able to receive subsequent identical workpieces or tools at the same respective position as the initial workpiece or tool, so that the tool is applied at exactly the same position to a subsequently inserted conventional workpiece and produces an identical product from each subsequent conventional workpiece.

To achieve such a consistent result, the work-holding-collet and a selected work stop of the work-holding-collet should have an adaptable relationship such that when the selected work stop has positioned the workpiece, such as by axially locating the workpiece at a selected depth in line with the collet mouth, the work stop is not interfering with operation of the work-holding-collet. As a matter of efficient choice, each work stop should be adjustable within the work-holding-collet over the full useful range of available work stop positions so that there can be no accidental interference with the work-holding-collet.

A work stop-rod sometimes is a dual diameter rod, with a non-uniform lengthwise profile such as one end having relatively wider diameter and the other end a relatively narrower diameter. Where a non-uniform lengthwise profile is in use, an efficient choice may employ the narrower end to mount and carry the work stop-rod and the wider end to be the depth stopping end of the rod, rather than the opposite with a narrower work-stopping end and a wider end for mounting and carrying the rod.

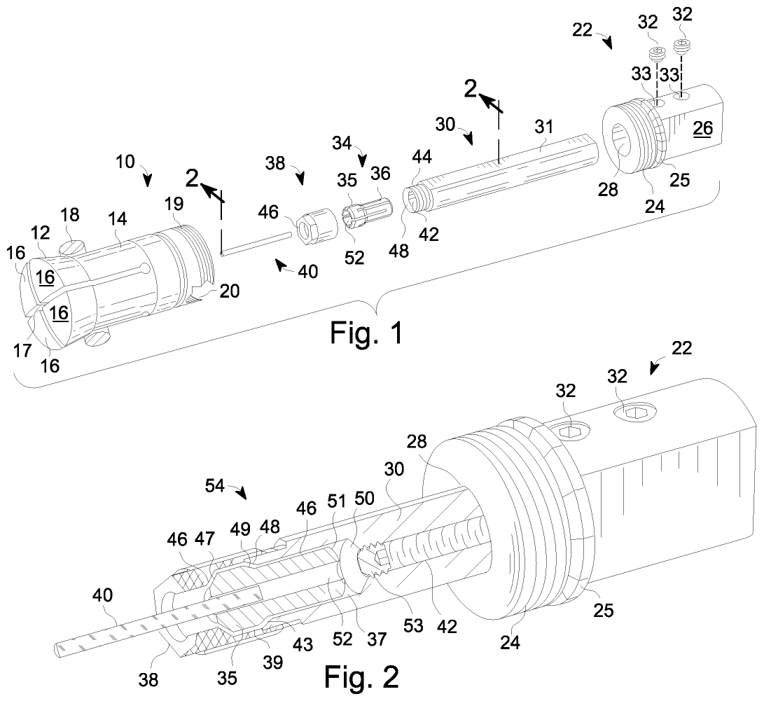

In the first embodiment best shown in FIGS. 1 and 2, elements of the work-holding-collet can be removed from the work-holding-collet 10 to be adjusted outside the work-holding-collet 10. The removable parts, together, can be referred to as a first removable component of the work-stop assembly. A main work-stop body 22 is a first part of the first removable component, is directly connected to the work-holding collet 10, and can be screwed or unscrewed from the work-holding-collet 10. The remaining parts of the first removable component are supported by the main work-stop body 22 in a passageway 28. These components are a shank 30 that is axially slidable in the axial passageway 28 through the main work-stop body 22; a stop nut that is threaded to the front of the shank, forming a stop-collet cavity between the nut and the front of the shank; and a stop-collet that can hold a work stop-rod 40 and fits in the cavity. The shank 30 is equipped with a hollow centerline bore behind the stop-collet cavity. The centerline bore may be threaded and may carry a threaded positive stop that can be positioned where desired behind the stop-collet cavity. The internal stop-collet 34 has front jaws that can be tightened by tightening the nut on the shank. The threaded mounting of the main work-stop body 22 enables repeatable precision engagement between the work-holding-collet 10 and the main work-stop body 22, which in turn enables precision engagement between the entire work-stop assembly and, eventually, a work stop-rod that can be mounted in the stop-collet. The rod 40 is optionally considered to be a component of the work-stop assembly, as it is changeable. One type of repeatable precision engagement is by threaded mounting between the rear of the work-holding-collet tube and the main work-stop body 22 to a point of full engagement. The main work-stop body 22 defines the passageway axially in line with the workpiece-receiving mouth of the work-holding-collet. When the work-holding collet is in use and mounted on a spindle of a suitable machine tool, the position of the passageway also is aligned with the spindle of the machine tool on which the work-holding-collet 10 is mounted. The portion of the work-stop assembly that is slidable in the passageway can be rapidly and accurately locked in place in the passageway by one or more non-marring setscrews threaded through the main work-stop body and into the passageway. These setscrews clamp onto a flat side of the shank 30 in the passageway, thereby holding the work-stop assembly in place with respect to the main work-stop body. The removable work-stop assembly can be considered to only optionally include the work-stop body because it is possible to remove the shank from the work-holding collet 10 at passageway 28 instead of requiring removal of the entire main work-stop body from the work-holding-collet 10.

The work-stop assembly has either a single angle or double angle stop-collet for clamping selected sizes of work stop-rods. To fasten and unfasten such work stop-rod, the work-stop assembly can be broken down into a rearward shank that slides in the passageway and defines the flat side, and a forward nut that threads onto the front end of the shank. A compression chamber is formed at the junction of the shank and nut to receive the stop-collet and to tighten the stop-collet jaws by increasing threaded engagement of the nut on the shank. The nut and shank have an axial bore allowing depth passage of any work-stop-rod that can he secured within the fastening range of a chosen stop-collet. The size range of the stop-collet determines acceptable rod diameters. Stop-collets of different size ranges might fit the compression chamber and can be substituted in the compression chamber. The axial bore of the nut and shank should be large enough to not limit the use of otherwise fitting stop-collets.

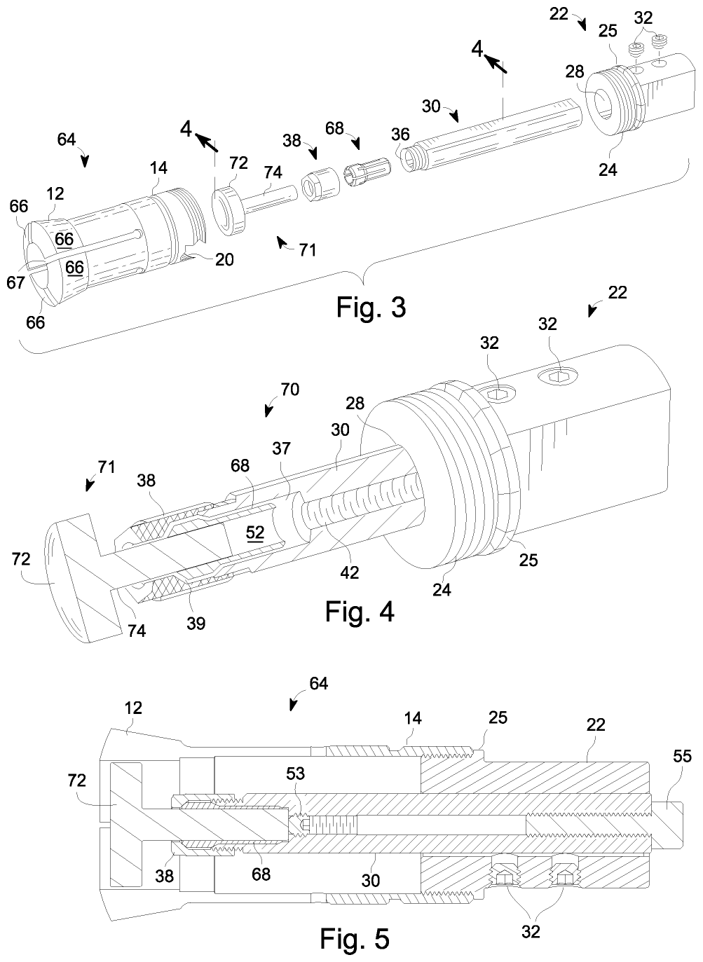

A second embodiment is best shown in FIGS. 3, 4, and 5 supports a tee-square stop-rod 71 with a broad head, beat suited for use with workpieces that are both radially wide and axially thin, such as washers. This type of stop-rod 71 can be troublesome unless it is held accurately. To achieve sufficiently accurate holding of stop-rod 71 in the passageway of the main work-stop body, the passageway is configured to have a one or more clamps to the slidable shank with equal lengths of the passageway both fore and aft of the one or more clamps.

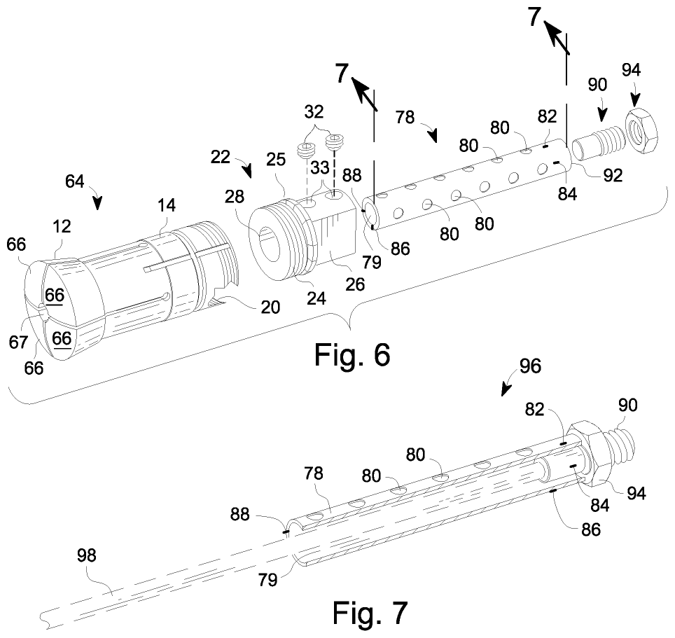

A third embodiment of the stop assembly best shown in FIGS. 6 and 7 comprises a similar main work-stop body that is removably affixed to the rear of the work-holding-collet tube; a tube stop with open front and closed rear, that is slidable is an axial passageway of the work-stop body; an axially adjustable rod closing the rear of the tube stop; and a position securing fastener for fixing the position of the rod in the tube stop. As before, the fastening of the work-stop body enables repeatable precision engagement between the work-holding-collet and the work-stop body. Such repeatable precision engagement is by threaded engagement between the work-holding-collet and the work-stop body to a point of full available engagement. The work-stop body defines a passageway axially in line with the workpiece-receiving mouth of the work-holding-collet. A portion of the work-stop assembly that is slidable in the passageway can be rapidly and accurately locked in place in the passageway by one or more non-marring setscrews threaded through the main work-stop body and into the passageway.

In this third embodiment, the work-stop assembly includes a tube stop in the form of a hollow tube with an array of setscrew reception holes in the sidewall of the tube. The setscrews can secure the tube stop in a rough workpiece blocking position by being inserted through reception holes matching the spacing pattern of the setscrew positions. The tube stop has an open front to receive in the tube a tail or stem of a long workpiece or other as may be desired. A further portion of the work-stop assembly is an adjustable work stop fastened in the rear end of the tube stop to establish a limit of insertion depth by workpiece tails inserted in the front of the tube stop. The work stop may be a threaded rod that is selectively engaged in the rear of the tube stop. A jam nut of the work-stop assembly is threaded onto the threaded rod to lock the threaded engagement with the tube stop.

It is readily understood that all three embodiments employ the work-stop body to be a selective attachment element to the work-holding-collet. The passageway in the work-stop body provides aligned mounting of the work-stop assembly with the central axis of the work-holding-collet, ultimately aligning a stop-rod with the workpiece-receiving mouth of the work-holding-collet. Two position adjusters set the depth of the forward end of the stop-rod. The two position adjusters cooperate, with the first carrying the second, and the second carrying the work stop. One of the two adjusters is conveniently set while the work-stop assembly is removed from the work-holding-collet. This first adjustment is an approximate or rough adjustment to approximately place the work stop at a suitable depth where it will block an incoming workpiece. The second adjuster is axially moved while the work-stop body is installed in the work-holding-collet, which allows exact measurement of the depth of the work stop. The second position adjuster sets the final position of the work stop.

With reference to the drawings, the numbering may employ the same identification number in different drawing figures and in connection with varied embodiments. In instances where the same number is used, the identified component will be the same or closely similar to other components identified by that number. The invention is shown with a forward end positioned generally to the left and as though components are arranged along a longitudinal axis between front and rear ends.

According to FIG. 1, in a first embodiment of the invention a work-holding-collet 10 is formed from a tube to have a forwardly flared, conical front end 12 and a rearwardly extending tubular body 14 containing what is known as the capacity bore. The conical front 12 and a portion of the tubular body 14 are split to define several jaws 16, such as an array of four jaws 16 that together define a workpiece-receiving mouth 17 and segmented collar around an axially inserted workpiece. The tapered, conical surface of the flared front 12 provides a means for simultaneously clamping the jaws 16 against the workpiece by forwardly, axially advancing a clamping ring 18 over the flare from narrow end of the taper toward broader end. The rear end of the axial tube 14 has external precision threads 19 to be attached at a matching threaded draw tube of a machine tool. The threaded engagement establishes a fixed spatial relationship between the work-holding-collet 10 and the machine tool. This fixed relationship allows the machine tool to reliably operate the work-holding-collet 10. Work-holding-collets can be given sizes such as 5C or 16C according to known standards, further enabling the associated machine tool to operate the installed work-holding-collet 10 according to expected specifications.

A work-holding-collet 10 is sized, in part, according to the capacity of the machine tool it will work with. For example, a machine tool that employs a work-holding-collet 10 is equipped with a clamping ring 18 that fits around tubular body 14 and is variably engaged over flared end 12 according to a desired degree of clamping to close or open the jaws 16. The jaws close or are more tightly clamped as the clamping ring 18 is applied against a larger diameter of taper 12, and the jaws open or are more loosely clamped as the clamping right is applied against a smaller diameter of taper 12. A work-holding-collet 10 is sized to receive a suitably dimensioned workpiece or tool in its jaws 16. For example, the workpiece or tool must have a rear portion small enough to fit in the workpiece-receiving mouth 17 at the center between the jaws 16 before the jaws are tightened against the workpiece, and the workpiece must be large enough that the jaws will be clamped against it when closed. The work-holding-collet 10 also must be selected to have internal capacity sufficient to handle the workpiece. For example, a portion of the workpiece is inserted into the work-holding-collet 10 behind the jaws 16, and the work-holding-collet 10 must accommodate the inserted portion. Such accommodation involves depth and diameter or cross dimension of the workpiece and may involve initial setting and subsequent resetting of the position of the workpiece in the work-holding-collet 10.

Interior precision threading 20 likewise may be formed on the rear internal surface of the work-holding-collet 10, shown at a rear breakaway at a right hand lower corner of the tube wall 14 in FIG. 1. The internal threading provides a symmetrical mount for receiving a main work-stop body 22 at the rear of the work-holding-collet 10. The main work-stop body 22 has a threaded front ring or field 24, with threads configured for mating with the rear interior field of threads 20 of the work-holding-collet 10. The rear end of the field of matching threads 24 is backed by a flange 25 that uniformly grounds against the rear edge of the field of threads 20 of the work-holding-collet 10 at full or maximum available engagement between the two fields of threads. The lead angle of flange 25 can be likened to a screw thread lead angle of zero.

The work-stop body 22 has a rear end with side flats 26 for engagement by a tool for rotationally twisting the main work-stop body 22, such as to insert or remove the main work-stop body 22 with respect to the work-holding-collet 10. Full or maximum available threaded engagement between the field of threads 24 and field of threads 20 is defined as the degree of engagement when the flange 25 at the rear of threads 24 is grounded against the rear edge of the work-holding-collet 10 to establish a repeatable position of engagement. Flange 25 and the rear edge of the work-holding-collet 10 are precisely perpendicular to a longitudinal central axis of the main work-stop body 22. The main work-stop body 22 has a centerline passageway 28 which may be cylindrical and collinear with the longitudinal central axis of the work-holding-collet 10 and aligned with workpiece-receiving collet mouth 17. The centerline passage 28 establishes at least a portion of the internal capacity of the work-holding-collet 10 for receiving a workpiece.

When a workpiece is fitted into the jaws 16 and workpiece-receiving mouth 17 of the work-holding-collet 10, it is centered on the longitudinal axis of the work-holding-collet 10 as well as on the central longitudinal axis of passage 28. This centering establishes two dimensions of uniform and repeatable positioning. In the first embodiment, the third dimension of uniform and repeatable positioning is established by a distance of penetration of the workpiece into the front end of work-holding-collet 10. With appropriate dimensions, the workpiece can advance along the longitudinal central axis of the work-holding-collet 10 it is blocked or until no further room for penetration is available. However, the end of such room for advancement, by itself, typically will not be the desired limit of penetration for the workpiece. Typically it is necessary to locate a selected limit of penetration by use of an interposed mechanism or object creating a work stop within the work-holding-collet. A practical problem with an internal work stop is difficulty in rapidly and accurately setting the position of the work stop and resetting the axial position of the work stop as necessary.

Third dimensional adjustment of the workpiece is handled by a work-stop assembly 54, FIG. 2, which operates along the longitudinal central axis of the work-holding-collet 10 by sliding within passage 28, FIG. 1. The work-stop assembly 54 includes a small stop-collet 34 at its front end, serving as one or two position adjusters for a work stop-rod 40. The stop-collet allows penetration into the small collet to a variably selected depth. The work-stop assembly 54 itself is formed of a shank 30, a nut 38 on the front end of the shank. The shank serves as a first position adjuster by moving in passageway 28. The nut and shank have a centerline hollow core 42 in line with a hollow center of the stop-collet 34. A head compression cavity 39 is formed between the front of the shank and the nut and contains the stop-collet 34. The head cavity 39 is configured to tighten the front jaws of the stop-collet 34 as the nut is tightened and vice versa. The tail of the stop-collet 34 backs into a tail cavity 37. Particularly where the stop-collet 34 is a double angle collet, the rear of the tail cavity is configured to tighten the rear jaws as the nut is tightened and vice versa. Together, three angular interactions shown in FIG. 2 with the front and rear jaws establish equal clamping force on a work-stop-rod or whatever is being held in the stop-holding collet. While the work-stop assembly is removed from the body of the work-holding-collet 10, a work stop-rod 40 can be inserted into stop-collet 34 and into whatever portion of hollow core 42 is necessary. The rough position of the work stop-rod in the stop-collet 34 can be chosen and nut 38 can be tightened on shank 30 to lock the work stop-rod 40 in the rough position. The rear end of the shank 30 then is inserted into passageway 28 and the work-stop body 22 is attached to the rear of work-holding-collet 10. It is then possible to insert the workpiece or a measuring rod into the workpiece-receiving mouth 17 that whatever precise depth is suitable. When the shank 30 is at the corresponding position in passageway 28, the shank is secured by setscrews 32 as they are set through counterbores 33 through the work-stop body 22 and into passageway 28. The shank 30 can be rotated to place its flat edge 31 to be contacted by the advancing setscrews 32.

In greater detail, the work-stop body 22 is attached to the rear of the work-holding-collet 10 in threaded engagement that, when fully threaded together, produces a single, fixed, reproducible position between the work-holding-collet 10 and work-stop body 22. The threading is positioned at a radius greater than the radius of passage 28 so that the threaded connection is outside the path of the work-stop assembly 54 and does not limit the available axial position of the work-stop assembly 54.

The work-stop assembly 54 is a compound axial slider operating in passageway 28. Axial adjustment is made by linear movement of the slider within passage 28. The slider is formed in part by a shank 30, which is a longitudinal tube that is sized to accurately fit passage 28. The tube is generally cylindrical and of diameter to fit passage 28, but with a longitudinally extending external flat edge 31 that engages with the setscrews 32. Rotationally positioning the flat edge 31 to face setscrew counterbores 33, enables shank 30 to be secured in a selected axial position in passageway 28. Setscrews 33 establish a lock when secured against flat edge 31. A preferred location for the counterbores 33 is near the rear end of the passage 28. The shank 30 can be rotated on the axis of passage 28 to orient the flat edge 31 to face the counterbores 33. The setscrews 32 are nonmarring, flat point, socket setscrews. The use of this type of setscrew preserves the flatness of edge 31 against marring, thereby ensuring that the shank continues to be precisely lockable in any selected axial position with respect to the work-stop body 22.

The stop-collet 34 is smaller than work-holding-collet 10, is a further component of the work-stop assembly, and readily fits inside the tubular body 14 for allowed longitudinal movement. The stop-collet 34 has a front compressible head 35 with a mouth operated by jaws. Stop-collet 34 also has a trailing tail 36 with a through passage that fits in line with core 43. The front end of the shank 30 forms a tail cavity 37 that receives the tail 36 of the stop-collet 34 and leaves the head 35 with its rear edge grounded against the rear end of a rear edge 49 of the head cavity 39.

Stop nut 38 of the work-stop assembly fits by threaded engagement over the front end of the shank 30, and forms a front portion of interior head cavity 39. The front of cavity 39 fits over the front of head 35 of the stop-collet 34. Increasing engagement of the threaded connection between stop nut 38 and shank 30 compresses the collet head 35, closing the jaws and mouth of stop-collet 34 on an inserted work stop-rod 40, if present. Contacting surfaces of the stop-collet head 35 and head cavity 39 are angularly configured with flares and tapers to further help compress the jaws of the collet head 35 when the nut 38 is tightened on the shank 30. A work stop-rod 40 can be secured at a selected forward extension from the stop-collet 34 by tightening the stop nut on the shank, thereby compressing head 35. Thereafter, the shank 30 is inserted into passage 28, and the work-stop body 22 is fastened by its predetermined engagement with work-holding-collet 10. Then, it becomes possible to insert a workpiece into work-holding-collet 10 and determine a desired length of insertion into work-holding-collet 10. When the insertion is so determined, the shank 30 is pushed forward placing the work stop-rod against the workpiece and secured in position by tightening setscrews 32 on the shank.

A benefit of the described dimensional adjustment through axial movement of the work-stop assembly is that the work stop-rod 40 can be selected with great variation. A low-cost, conventional gage pin is suitable. The length of the gage pin need not be custom machined for each job, because a rough, preliminary setting in stop-collet 34 is sufficient to eliminate this common need. The further length adjustment by setting the shank 30 in the passageway 28 of the work-stop body 22 provides additional precision of depth setting without modification of the gage pin.

Additional features support the flexible choice of a work stop-rod 40. The shank 30 has a hollow longitudinal center bore 42 and an externally threaded front end 44. As shown in FIGS. 4 and 5, the center bore 42 is threaded, either from end-to-end or at selected portions. At the front end, center bore 42 has front portion of enlarged diameter that defines the internal collet tail cavity 37. The stop nut 38 has a threaded rear end that threads onto the front thread 44 of the shank 30. The stop nut 38 has a hollow center forming the internal head cavity 39 in position to align when assembled with hollow center 42 of the shank.

As best shown in FIG. 2, the stop cavity 37, 39 and stop-collet 34 have contact surfaces that aid the closing action of the collet jaws. A front edge of the stop nut in head cavity 39 is configured as a rearward, outward flare 46 opposed by a rearward, outward flare on the front peripheral surface 47 of the collet head 35. The peripheral front end 48 of the shank 30 has a forward and outward flare 48 that is opposed by a forward, outward flare 49 of the peripheral rear edge of the collet head 35. As shown by the matching opposed edges 46, 47 and 48, 49, when the stop nut 38 is tightened on the front threads 44 of the shank 30, the collet head chamber applies compressive force to the collet head 35, tightening the collet 34 on the work stop-rod 40, if present. The stop-collet 34 is functionally tightened or loosened by respectively increasing or decreasing the threaded engagement between the nut 38 and shank 30. The engagement angles between the cavity and angles of the collet head are preferred to be matching so that the compressive pressure is equal at each angular interface.

Various types of stop-collets 34 are suitable for use, including a single angle collet or a double angle collet. The illustrated collet 34 is a double angle collet, also known as a DA collet, and is a preferred choice. Such a double angle collet is split to form jaws at both front and rear ends. At the forward end, a DA stop-collet has an enlarged head with clamping jaw, as shown at the front of collet 34 in FIG. 1. The DA collet also has clamping jaws formed at the tail end, although the tail end is not formed as an enlarged head. This jaw structure is shown at the tail end of collet 34 in FIG. 1. A single angle collet has the front jaws and head as shown in FIG. 1, but the tail is not configured as jaws. Thus, in a DA collet the tail chamber 37 has peripheral end wall 50 with a forward, outward flare, opposed by the collet tail peripheral end wall 51 having a matching forward, outward flare. When the stop nut is tightened, forward pressure is applied to the end wall 51. The angles at the tail preferably match the angles at the head so that applied pressure is equal to the pressure applied at the head. Tightening the stop nut 38 on the shank 30 tightens jaws at both ends of DA collet 34. A centerline bore 52 through stop-collet 34 is aligned with the hollow center 42 of the shank, allowing reception of a work stop-rod 40 through the entire collet centerline bore 52 with extension into hollow center 42 of the shank.

A work stop-rod 40 preferably is a uniform diameter rod. One suitable type of rod is a conventional gage pin. This choice is desirable because a gage pin is a convenient and inexpensive option. Gage pins are handy because they are available in very minute increments—usually 0.001 inch steps—and affordable. In some applications where it may be preferred to not use a gage pin, other types of work stop-rod blanks also are suitable. As an example and not a limitation, suitable rod blanks may be drill rod, dowel pins, precision shafting, cylindrical rod, gage pins or the like. A chosen work stop-rod is axially aligned to enter the capacity bore of the work-holding-collet 10 and to enter the stop-holding hollow center 52 of an appropriately sized stop-collet 34. As shown in FIG. 5, the threaded front of the shank 30 may contain a threaded bore-closing element such as setscrew 53, which serves as a backstop for a narrow stop-rod 40 such as a gage pin or the like. As also shown in FIG. 5, the rear end of shank bore is closed by a bolt 55, which is a material stop to allow versatile usage of the shank. With bolt 55 in place, the shank 30 can be turned end-to-end and used in such a reversed position. The bolt 55 then is a stop for a workpiece inserted from the front of the work-holding-collet 10.

In the first embodiment, the sliding assembly of FIG. 2 includes a shank 30, an internal stop-collet 34, and a stop nut 38, together adapted to adjust and secure a work stop-rod 40 in forward extending, length adjustable relationship. This assembly can be referred to as the sliding portion 54 of a work-stop-assembly. The carried work stop-rod 40 can be adjusted in two ways with respect to the work-holding-collet 10. First, it can be roughly adjusted in the stop-collet 34, by an adjustment process that takes place when assembly 54 has been removed from the work-holding-collet 10. After adjustment, the sliding assembly 54 is reinstalled in the work-holding-collet 10. Second, a carried work stop-rod 40 can be precision adjusted after the work-stop assembly is reinstalled in slide passageway 28, which as a prerequisite has been attached to the work-holding-collet 10. Thus, a typical precision adjustment will be carried out by inserting a measuring device through the workpiece-receiving mouth 17 of the work-holding-collet until it contacts the front of the roughly adjusted work stop-rod 40. Then, the measuring device and work stop-rod are moved together while maintaining contact, by sliding in passageway 28 to place their meeting point at a precision depth in the work-holding-collet 10. The precision depth is fixed by securing the sliding portion 54 in passageway 28, such as by clamping the sliding element 30 of assembly 54 in place.

An internal stop-collet 34 can handle gage pins or other work stop-rods 40 over a range of diameters. For example, a ⅛ inch DA collet might accommodate gage pins over a size range of 0.5 mm. Different capacity stop-collets 34 can be accommodated in the head cavity 39 and tail cavity 37, further expanding the range of sizes for work stop-rods 40 that can be handled within the same shank 30.

An improvement of the invention is that uniform work stop-rods 40 such as gage pins or others are readily available in a variety of standard sizes, and a selection of such standard sized work stop-rods are directly useable as collet stops with a single internal stop-collet 34. The component parts of an assembly 54 offer changeability of sizes to fit a suitable gage pin or other work stop-rod for the needs of the work-holding-collet 10 to handle a particular workpiece. Changeover entails exchanging work stop-rod 40 of the desired size into the collet 34, tightening the stop nut 38, sliding the shank 30 to a final position in passage 28 for the job, and tightening the two setscrews 32 into counterbores 33 and against the shank. By this system, notable time consuming and often costly steps are eliminated. In particular, where in the prior art the work stop-rod 40 may need custom machining at each step in a fabrication, the present system is adaptable to use a set of different sized, standard gage pins or other mentioned examples as work stop-rods. Where in prior art the work stop-rod often used multiple diameter segments due to the need to clamp the work stop-rod at a fat middle section, the present system uses single diameter, standard work stop-rods, which can be received in a small, internal stop-collet 34 that accommodates a variety of rod diameters. Where in the prior art a work stop-rod carrier was screwed into the work-holding-collet 10 and adjusted by manipulation of the entire work-holding-collet, the present system offers simple rough adjustment of the work-stop assembly 54 while it is removed from the work-holding-collet 10, with final adjustment by simple sliding action of the shank 30 in bore 28 and clamping the shank with setscrews. Thus, changeovers are done rapidly and inexpensively, without requiring further machining of the work stop-rod 40.

FIGS. 3, 4 and 5 show a second embodiment of the work stop-rod of the first embodiment of the invention. The relative capacity of the work-holding-collet 64 appears larger because the Jaws 66 form a larger diameter work-receiving mouth 67 between the jaws 66. This diameter of mouth 67 is relatively larger than the mouth 17 of work-holding-collet 10 of FIG. 1 for an equivalently sized work-holding-collet. Thus, one problem is in the fit of the collet 68 inside work-holding-collet 64—that the workpiece to be received in the mouth 67 may have such a large diameter that a corresponding, necessarily large internal stop-collet 68, FIGS. 3 and 4, cannot fit into the work-holding-collet 64. A second problem is in limited size of the work stop-rod 40—that the workpiece may be so transversely wide and longitudinally thin that a work stop-rod 40, FIG. 1, provides insufficient backing support for the workpiece. In the latter case, the result is that during machining operations the workpiece might wobble with respect to the work-holding-collet 64 even when secured in two dimensions by jaws 66 in the collet mouth 67 and longitudinally stopped in the third dimension by a work stop-rod 40.

FIG. 4 shows a slidable work-stop assembly 70 that resolves the problem of needing more backing support to prevent workpiece wobble. A square stop or tee-square stop 71, FIG. 3, has a broad head 72 suited to the needs of the broad, thin workpiece. The broad head of the tee-square stop is smaller in size than the nominal size of the work-holding collet 64. The face of the tee-square stop is substantially perpendicular to the axis of the carrier rod 74, which in turn makes it perpendicular to the spindle of the machine carrying the work-holding collet for use. A narrower carrier rod 74 sized similarly to a gage pin 40, FIGS. 1 and 2, solves the problem of carrying and exchanging the broad head stop 71 in the mouth 67 of the large-mouthed work-holding-collet 64. The broad head 72 is carried on a carrier rod 74 that fits the internal stop-collet 68. A variety of broad-headed tee-square stops 71 can be carried on a single size of carrier rods 74, preserving the rapid changeover of stops 71 that is enabled by the use of the internal stop-collet 68 in the stop-collet cavity 37, 39 of a slidable shank 30. Internal stop-collets 68 of different sizes are easily exchanged in cavity 37, 39, having the capacity to receive carrier rods 74 over a range of sizes. Thus, a single work-holding-collet 10, 64 is provided with work stop-rods 40, 74 dimensioned over the capacity of the work-holding-collet 10, 64.

The work-holding-collets 10, 64 provide improved simplicity in making both rough and final position settings of a work stop-rod. The rear end of the workpiece likely is located inside the work-holding-collet 10, 64. The stop-collet 34, 68 likewise is internal to the work-holding-collet 10, 64. In each embodiment, a preliminary or rough setting of a work stop is made outside the work-holding-collet. Fine or final adjustment of the work stop with respect to the work-holding-collet 10, 64 is made from outside the work-holding-collet.

In the embodiment of FIGS. 3, 4, and 5, the work-stop body is configured with equal lengths of the passageway 28 on both the front end and rear end of the passageway 28 and with the clamping setscrews 32 in a center of the length. This pattern of the setscrews 32 is centered from end to end on the passageway 28. This will help to eliminate any tilt in the shaft 74 that may result from the bolt pattern being off-center. It is important that the shaft 74 be parallel to the spindle of the machine so that when we use the tee square accessory 71, the face 72 of the tee square 71 is square to the rotation of the spindle.

FIGS. 5 and 6 show a third embodiment of the invention, which is an apparatus to accommodate a long workpiece. In the first embodiment, the work stop 40 is presented from the front of a supporting structure and generally to front of the passageway 28. In this second embodiment the work stop 90 is presented at the back of a supporting structure and generally to the back of the passageway 28. Also, thanks to the forward positioning support for the work stop supplied by a forwardly extending tube 78, the stop-collet used in the prior embodiment is conveniently replaced by threaded engagement between the work stop and the tube. The functioning of the tube can be compared to the stop-collet. Both engage the rear end of the work stop in a tight grip, the stop-collet using jaws and the tube using engaging threads and a jam nut. The jaws of the stop-collet prevent the work stop from axial movement after the jaws close on it. The threads of the tube prevent the work stop from axial movement after the threads engage and the jam nut engages the tube. Both the stop-collet and the tube operate in one direction—depth—the 3^{rd} dimension as employed in this disclosure.

The work-holding-collet 64 of FIG. 5 is adapted to handle a workpiece 98, FIG. 6, which is longer in length than conveniently accommodated in the first embodiment, such as where the length is greater than available in work-holding-collet 10. An example of such a workpiece 98 might be an elongated rod. The work-holding-collet 64 is similar in structure and function to the identically numbered work-holding-collet 64 of FIG. 3. The workpiece-receiving mouth 67 is continuous through work-holding-collet 64 and through the passageway of main work-stop body 22, which as previously described is threaded to the rear end of work-holding-collet 64. As further previously described, work-stop body 22 has a ring or field of threads 24 at the forward end that engages with the ring or field rear threads 20 of the work-holding-collet 64. A grounding flange 25 located at the rear of thread ring 24 meets the rear edge of the work-holding-collet 64. A centerline passageway 28 passes through main work-stop body 22 in longitudinal alignment with workpiece-receiving mouth 67 of work-holding-collet 64 so that an elongated workpiece 98 can pass through both work-holding-collet 64 and work-stop body 22 on the center axis of passage 28.

An axially elongated tube stop 78, also referred to as a bucket stop, fits closely within passage 28, where it is secured in at selected depth within work-stop body 22 by setscrews 32. Tube stop 78 has an elongated hollow core that is axially aligned with the centerline of the work-holding-collet 64 and work—stop body 22, which enables an elongated workpiece 98 to be inserted through workpiece-receiving mouth 67, through passage 28, and into the core 79 of tube stop 78 by a selected distance. Tube stop 78 is configured with an array of transverse receptor holes 80 arranged at a longitudinal periodic spacing along the length of the tube stop 78. The illustrated two setscrews 32 can be placed into any pair of successive reception holes 80 to establish a positive stop for an inserted workpiece 98. The periodic distance spacing of reception holes 80 is coordinated with the axial separation of the counterbores 33 so that a longitudinally successive pair of reception holes 80 is secured to the pair of setscrews 32. The collet jaws 66 continue to function as the work holder during machining operations.

The adjustable tube stop body 78 is a tubular or cylindrical metal adaptor for elongated workpieces and is held in place with non-marring setscrews 32. The tube stop body 78 has the series of reception holes 80 that will not allow the tube stop body to move either axially or rotationally when the non-marring setscrews 32 are tightened into selected reception holes 80 of the tube stop body. The reception holes 80 in the tube stop body 78 are arranged in a plurality of “R” axial rows, such as where R=4. Such four axial rows would be positioned on the tube stop body at rotationally separated positions. Starting at a twelve o′clock position 82 in FIG. 5 or as otherwise referred to as a zero degrees position, a first row 82 is at zero degrees; a second row 84 is at ninety degrees; a third row 86 is at one-hundred eighty degrees; and a fourth row 88 is at two-hundred severity degrees. In each row, the series of reception holes 80 is axially offset over the pattern of the prior row. Where R=four, the offset is 1/R or one fourth of the separation between counterbores 33 in the work-stop body 22. Thus, the two setscrews 32 and counterbores 33 can be aligned with two successive reception holes 80 in any one of the four rows to establish an axial position of the tube stop body 78 with respect to the work-stop body 22. Each row may have a plurality of “N” successive reception holes 80, such as N=six, which would permit positioning the tube stop body at (N-1) or five positions employing only a single row of six reception holes 80. A longitudinal offset as small as one-quarter the distance between counterbores 33 is achieved by rotating the tube stop body 78 by 1/R or one-quarter turn to a next row and aligning matching reception holes 80 of that next row with the positions of two setscrews 32 and counterbores 33 of the work-stop body 22. Thus, by rotating the tube by 1/R, or one-quarter turn, the axial position of the tube stop body 78 is moved by 1/R or one-quarter the distance between counterbores 33; and similarly, by rotating the tube 2/R or one-half turn or 3/R or three quarters turn, the axial position of the tube stop body 78 is moved by one-half or three-quarters the distance between counterbores 33. Matching the best positioned reception holes to the setscrew positions would still be a rough positioning of the tube stop, although in the example the rough setting should be within one-quarter inch of ideal.

The rear end 92 of the tube stop 78 is internally threaded. As evident, adjustment using the reception holes 80 is rough. A threaded work stop-rod 90 is engaged in threaded rear end 92 of tube 78 to make finer adjustment, which is achieved by rotating the work stop-rod 90. A threaded lock nut 94 secures the position of the work stop-rod when turned against the rear end of the tube 78. The work stop-rod 90 and lock nut 94 extend behind the rear of the work-holding-collet 64, such that they are external and exposed to enable fine adjustment from outside the work-holding-collet 64. Remaining adjustment such as screwing the work-stop body 22 into the rear end threads 20 of work-holding-collet 64 or setting the position of the tube stop 78 into the work-stop body 22 are fixed or repeatable even before the work-holding-collet 64 is mounted on a machine spindle, so that high precision can be achieved by external adjustment after the work-holding-collet 64 is fully mounted and carrying the workpiece 98.

The embodiment of FIG. 6 shows details of a tube stop assembly 96 of FIG. 6, which is the combination of a tube stop 78, a work stop-rod 90 and a lockout 94. Like the stop assemblies 54, 70 of FIGS. 2 and 4, respectively, the tube stop assembly 96 slides in passageway 28 of the main work-stop body 22 for adjusting the position of the rear end of the work stop-rod 90. Both coarse and fine adjustments are available. The choice of reception holes 80 is a coarse adjustment by aligning chosen holes 80 with positions of set screws 32 and counterbores 33. Fine adjustment is by rotating work stop-rod 90 on its threaded engagement with tube stop 78. For ease of preliminary assembly, the set screws 32 can be installed before the main work-stop body 22 is screwed into the rear tube 14 of the work-holding-collet 10.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. In a work-holding-collet having an elongated body centered on a longitudinal center axis, having a workpiece-receiving mouth centered on said axis at a front end of said work-holding-collet and a rearwardly directed mount on the rear of the work-holding-collet, a work-stop assembly comprising:
a work-stop body, selectively connected to the work-holding-collet on said rearwardly directed mount, having a through passageway aligned with the central axis;
a first work-stop position adjuster and a second work-stop position adjuster, wherein said first work-stop position adjusters is selectively engaged in slidable relationship within said passageway and carries said second work-stop position adjuster for axial movement with the first work-stop position adjuster;
wherein, when the first work-stop position adjuster is engaged in the passageway, both the first work-stop position adjuster and the second work-stop position adjuster are centered on said longitudinal axis; and
the second work-stop position adjuster carries a blocking element that is axially moveable with respect to the second work-stop position adjuster to, in use, establish an adjustable depth limit for reception of a workpiece into the work-stop body.

2. The work-stop assembly of claim 1, wherein:
said first work-stop position adjuster comprises an elongated shank engaged in said passageway and having a threaded front end; and
a stop nut threaded onto said threaded front end of said elongated shank;
said second work-stop position adjuster comprises a stop-collet carried at the front end of the elongated shank;
wherein the elongated shank and stop nut together define a cavity sized to house said stop-collet and configured with a front opening for, in use, receiving said blocking element into the stop-collet; and
wherein said cavity is configured to tighten the stop-collet by tightening the stop nut to, in use, fasten the blocking element at a selected depth-of-insertion into the stop-collet.

3. The work-stop assembly of claim 1, wherein:
said first work-stop position adjuster comprises an elongated tube engaged at a selected position in said passageway;
said blocking element is a stop-rod carried in the rear end of said elongated tube; and
said second work-stop position adjuster comprises a threaded engagement between said stop-rod and said elongated tube, allowing the stop-rod to be axially moved in the elongated tube by rotation on said threaded engagement to, use, adjust the axial position of the blocking element.

4. The work-stop assembly of claim 3, further comprising:
a rotation lock selectively fixing the axial position of said stop-rod in said elongated tube.

5. The work-stop assembly of claim 4, wherein:
said rotation lock is a jam nut on said stop-rod applied against the rear end of said elongated tube.

6. The work-stop assembly of claim 3, further comprising:
an axial position lock selectively fixing the axial position of said elongated tube in said passageway.

7. The work-stop assembly of claim 6, wherein said axial position lock comprises:
a setscrew mounted in said work-stop body for application to said elongated tube in said passageway; and
wherein said elongated tube defines an array of axially spaced reception holes for engaging said setscrew in a user selected reception hole of said array, the selected reception hole determining the locked axial position of the elongated tube in the passageway.

8. The work-stop assembly of claim 6, wherein said axial position lock comprises:
a plurality of setscrews arranged at a selected longitudinal spacing and mounted in said work-stop body for application to said elongated tube in said passageway; and
wherein said elongated tube defines an array of reception holes for engaging said plurality of setscrews, the reception holes of said array being arranged in a longitudinal row with said selected axial spacing between plural reception holes of said row.

9. The work-stop assembly of claim 8, wherein said axial position lock further comprises:
said array of reception holes is arranged in a plurality of axial rows oriented at a rotational separation, with axial offset between reception holes of adjacent rows at less than said selected axial spacing, whereby the choice of a selected axial row for engagement by said setscrews allows the position said axial tube to be locked in a different axial position than available by choice of a different axial row for engagement by the setscrews.

10. The work-holding-collet of claim 1, wherein:
said rearwardly directed mount on the rear of said work-holding-collet comprises an inside threaded field; and
said work-stop body comprises:
a front outside threaded field adapted to engage said rear inside threaded field of said work-holding-collet to mount the work-stop body on the rear of the work-holding-collet; and
a grounding flange positioned to ground against a rear edge of the work-holding-collet at maximum available engagement with the work-stop body, establishing a reproducible position of engagement,

11. The work-holding-collet of claim 1, wherein said work-stop body comprises:
an axial position lock mounted in said through passageway for application to said first work-stop position adjuster;
wherein, said axial position lock is centered from end to end of the through passageway to maintain the axial position lock in alignment with said longitudinal center axis.

12. The work-holding-collet of claim 11, wherein said blocking element comprises a tee-square stop.

13. A work-holding-collet with a longitudinal front to rear axis, formed of a collet body with flared front body portion defining a ring of compressible jaws around a central work-receiving collet mouth, and with a tubular rear body portion located longitudinally rearward of the flared front body portion, comprising:
a work-stop body attached at the rear of said tubular rear body portion and defining a through passageway aligned with said work-receiving-collet mouth on said longitudinal front to rear axis; and
a work-stop assembly connected to said work-stop body in said through passageway and aligned on said longitudinal axis with the work-receiving-collet mouth;
wherein said work-stop assembly comprises:
a rod-stop having a work-blocking front surface positioned forward of the through passageway;
a shank carrying said rod stop in forwardly extending position from the front end of said shank, the shank being engaged in the through passageway for movement on the longitudinal axis with respect to the work-receiving-collet mouth, placing the front end of the rod-stop within the tubular rear body portion of said work-holding-collet at a selected spacing behind the work-receiving-collet mouth for, in use, blocking further rearward movement of a workpiece inserted from the front of the work-receiving-collet mouth;
and wherein:
the work-stop assembly has an associated lock operable between the shank and the through passageway securing the shank in a selectable fixed longitudinal position with respect to the passageway.

14. The work-holding-collet of claim 13, said work-stop assembly further comprising:
a rod-stop;
a double angle stop-collet; and
a stop nut progressively tightenable on the front end of said shank;
wherein said double angle stop collet has an enlarged head with front jaws defining a work-stop-collet forward mouth, said enlarged head having front and rear edges that are sloped to tighten said front jaws when compressive pressure is applied to said front and rear edges; and
the double angle stop collet has a tail with rear jaws defining a work-stop-collet rearward mouth, the tail having a rear edge that is sloped to tighten said rear jaws when forward pressure is applied to said rear edge;
wherein, when said stop nut is applied to the front end of the shank, a cavity sized to receive the double angle stop-collet is defined within the stop nut and front end of the shank, and said cavity is configured to apply compressive pressure to the front and rear edges of the enlarged head and to apply forward pressure to said rear edge as the stop nut is progressively tightened on the front end of the shank;
whereby, in use with said rod-stop inserted through the double angle stop collet, tightening the stop nut simultaneously clamps the rod-stop in the front and rear jaws of the double angle stop collet.

15. The work-holding-collet of claim 13, wherein said work-stop body comprises:
an axial position lock mounted in said through passageway to lock said shank in a selected position; and
wherein, said axial position lock is centered from end to end of the through passageway to maintain said axial position lock in alignment with said center axis.

16. The work-holding-collet of claim 15, wherein said rod-stop comprises a tee-square stop.

17. A work-holding-collet with a longitudinal front to rear axis, formed of a collet body with flared front body portion defining a ring of compressible jaws arranged around a central work-receiving collet mouth, and with a tubular rear body portion located longitudinally rearward of the flared front body portion, comprising:
a work-stop body attached at the rear of said tubular rear body portion and defining a through passageway symmetrically aligned with the workpiece-receiving mouth on said longitudinal front to rear axis; and
a work-stop assembly connected to the work-stop body in said through passageway and symmetrically aligned on the longitudinal front to rear axis with the collet mouth;
wherein the work-stop assembly comprises:
a rod-stop having a workpiece-blocking front surface;
a tube having an open front with a hollow-center carrying said rod-stop,
wherein the tube is engaged in the through passageway for longitudinal movement with respect to the workpiece-receiving mouth to position said workpiece-blocking front surface of the rod-stop at a selected spacing behind the workpiece-receiving mouth for, in use, blocking further rearward movement of a workpiece inserted in the front of the work-receiving collet mouth; and
the tube having an associated tube lock operable between the tube and the through passageway securing the tube in a fixed position with respect to the passageway.

18. The work-holding-collet of claim 17, wherein said tube lock comprises:
a setscrew mounted in said work-stop body for application to said tube in said passageway; and
wherein said tube defines an array of reception holes in an axial row positioned to engage said setscrew in a user selected reception hole of said row, the position of said selected reception hole determining the locked axial position of the tube in the passageway.

19. The work-stop assembly of claim 17, wherein said tube lock comprises:
a plurality of setscrews arranged at a selected axial interval and mounted in said work-stop body for application to said tube in said passageway; and
wherein the tube defines an array of reception holes for engaging said plurality of setscrews, the reception holes of said array being arranged in an axial row with said selected axial spacing between members of said row.

20. The work-stop assembly of claim 17, wherein:
said array of reception holes is arranged in a plurality of axial rows oriented at rotational separation and with axial offsets by less than said selected axial interval.
